(19) United States
(12) Patent Application Publication
(10) Pub. No.: US 2026/0356331 A1
(43) Pub. Date: Nov. 12, 2026

(54) WORK MACHINE, BRAKING SYSTEM FOR WORK MACHINE, AND CONTROL METHOD FOR WORK MACHINE

(71) Applicant: KOMATSU LTD., Minato-ku, Tokyo (JP)

(72) Inventors: Akira TAKENO, Minato-ku, Tokyo (JP); Masahiro UTSUMI, Minato-ku, Tokyo (JP)

(73) Assignee: KOMATSU LTD., Minato-ku, Tokyo (JP)

(21) Appl. No.: 19/138,356

(22) PCT Filed: Dec. 12, 2023
(86) PCT No.: PCT/JP2023/044378

§ 371 Date: Jun. 12, 2025

(30) Foreign Application Priority Data
Dec. 16, 2022 (JP) 2022-201324

(51) Int. Cl. B60T 7/22; E02F 9/16; E02F 9/20; E02F 9/24; E02F 9/26

(52) U.S. Cl. CPC B60T 7/22; E02F 9/16; E02F 9/2004; E02F 9/2083; E02F 9/24; E02F 9/261; B60T 2201/022

(57) ABSTRACT

Automatic braking control for automatically braking traveling is executed based on a detection result of an obstacle. A release device releases the automatic braking control by an operation by an operator. A traveling direction switching device switches a traveling direction by an operation by the operator. A controller returns the automatic braking control released by the operation of the release device based on a switching signal of the traveling direction in the traveling direction switching device.

### TECHNICAL FIELD

The present disclosure relates to a work machine, a braking system for a work machine, and a control method for a work machine.

### BACKGROUND ART

Japanese Utility Model Registration No. 3219005 (Patent Document 1) discloses collision prevention control for detecting a rear obstacle and automatically stopping traveling in a wheel loader which is an example of a work machine.

In the wheel loader illustrated in Patent Document 1, an area from the wheel loader to the object is divided into three areas, that is, a first area, a second area, and a third area in order of increasing distance from the object. In the collision prevention control, when an obstacle is present in the first area having the shortest distance from the wheel loader, the brake is automatically operated to stop the traveling of the vehicle.

### CITATION LIST

### Patent Literature

Patent Document 1: Japanese Utility Model Registration No. 3219005

### SUMMARY OF INVENTION

### Technical Problem

In Patent Document 1, the collision prevention control is released when an operator operates a control temporary release means. However, in order to continue to release the collision prevention control, the operator needs to continue to operate the control temporary release means. In this case, the operator must operate the traveling of the work machine and the operation of the work implement while operating the control temporary release means, and there is a possibility that a trouble occurs in a driving operation.

An object of the present disclosure is to provide a work machine, a braking system for a work machine, and a control method for a work machine that are less likely to cause a problem in a driving operation.

### Solution to Problem

Each of a work machine and the braking system for a work machine according to the present disclosure performs automatic braking control for automatically braking traveling based on a detection result of an obstacle. Each of a work machine and a braking system for a work machine according to the present disclosure includes a release device, a traveling direction switching device, and a controller. The release device releases the automatic braking control by an operation by an operator. The traveling direction switching device switches a traveling direction by an operation by the operator. The controller returns the automatic braking control released by the operation of the release device based on a switching signal of the traveling direction in the traveling direction switching device.

A control method for a work machine according to the present disclosure is a control method for a work machine configured to perform automatic braking control for automatically braking traveling based on a detection result of an obstacle, the control method including: releasing the automatic braking control; and returning the released automatic braking control based on a switching signal of a traveling direction.

### Advantageous Effects of Invention

According to the present disclosure, it is possible to realize a work machine, a braking system for a work machine, and a control method for a work machine that are less likely to cause a problem in a driving operation.

### BRIEF DESCRIPTION OF DRAWINGS

FIG. 1 is a side view illustrating a configuration of a wheel loader according to an embodiment of the present disclosure.

FIG. 2 is a block diagram illustrating a braking system for the wheel loader of FIG. 1.

FIG. 3 is a hydraulic circuit diagram illustrating a configuration of the braking device of FIG. 2.

FIG. 4 is a view illustrating arrangement positions of a traveling direction switching device and a release device.

FIG. 5 is a block diagram illustrating a configuration of an operation device, an object sensor, and a controller in FIG. 2.

FIG. 6 is a first flowchart illustrating a control method for a wheel loader according to an embodiment of the present disclosure.

FIG. 7 is a second flowchart illustrating a control method for a wheel loader according to an embodiment of the present disclosure.

FIG. 8 is a diagram illustrating ON/OFF transitions of the automatic braking control and the braking operation.

### DESCRIPTION OF EMBODIMENTS

Hereinafter, embodiments of the present disclosure will be described with reference to the drawings.

In the specification and the drawings, the same components or corresponding components are denoted by the same reference numerals, and redundant description will not be repeated. In the drawings, the configuration may be omitted or simplified for convenience of description. In addition, at least some of the embodiments and the modifications may be arbitrarily combined with each other.

### Configuration Of Wheel Loader 100

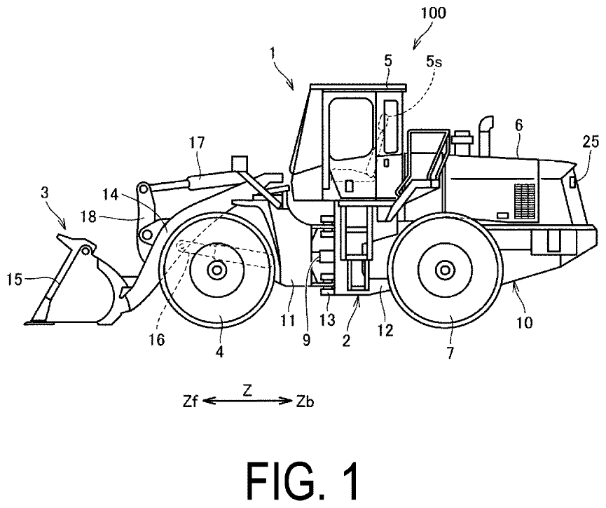

A configuration of a wheel loader 100 in the present embodiment will be described with reference to FIG. 1.

FIG. 1 is a side view illustrating a configuration of the wheel loader 100 (an example of a work machine) according to an embodiment of the present disclosure. As illustrated in FIG. 1, the wheel loader 100 in the present embodiment has a vehicle body 1 and an object sensor 25. The vehicle body 1 includes a traveling body 2 and a work implement 3. The work implement 3 is disposed on the traveling body 2. The traveling body 2 includes a vehicle body frame 10, a pair of front tires 4, a cab 5, an engine room 6, a pair of rear tires 7, and a steering cylinder 9. The wheel loader 100 performs earth and sand loading work or the like using the work implement 3.

In the following description, “front”, “rear”, “right”, “left”, “up”, and “down” indicate directions based on a state in which an operator seated on an operator seat 5s in cab 5 looks forward. In FIG. 1, the frontward-rearward direction is indicated by Z, the frontward direction is indicated by Zf, and the rearward direction is indicated by Zb.

The vehicle body frame 10 is of a so-called articulated type, and includes a front frame 11, a rear frame 12, and a coupling shaft portion 13. The front frame 11 is disposed in the frontward direction Zf of the rear frame 12. The coupling shaft portion 13 is provided at the center of the vehicle body frame 10 in the left-right direction (vehicle width direction), and couples the front frame 11 and the rear frame 12 to each other in a rotatable manner. The pair of front tires 4 are attached to the left and right of the front frame 11. The pair of rear tires 7 are attached to the left and right of the rear frame 12.

The work implement 3 is driven by hydraulic oil from a work implement pump (not illustrated). The work implement 3 includes a boom 14, a bucket 15, a lift cylinder 16, a bucket cylinder 17, and a bell crank 18. The boom 14 is attached to front frame 11. The bucket 15 is attached to a distal end of the boom 14.

The lift cylinder 16 and the bucket cylinder 17 are hydraulic cylinders. One end of the lift cylinder 16 is attached to the front frame 11, and the other end of the lift cylinder 16 is attached to the boom 14. The boom 14 rotates up and down by extension and contraction of the lift cylinder 16. One end of the bucket cylinder 17 is attached to the front frame 11, and the other end of the bucket cylinder 17 is attached to the bucket 15 via a bell crank 18. As the bucket cylinder 17 extends and contracts, the bucket 15 rotates up and down.

The cab 5 is placed on the rear frame 12. Inside the cab 5, the operator seat 5s for an operator to sit on, a steering wheel for steering operation, a lever for operating the work implement 3, various switches, a display, and the like are disposed. The engine room 6 is disposed on the rear frame 12 in the rearward direction Zb of the cab 5, and houses an engine 31.

### Braking System for Wheel Loader 100

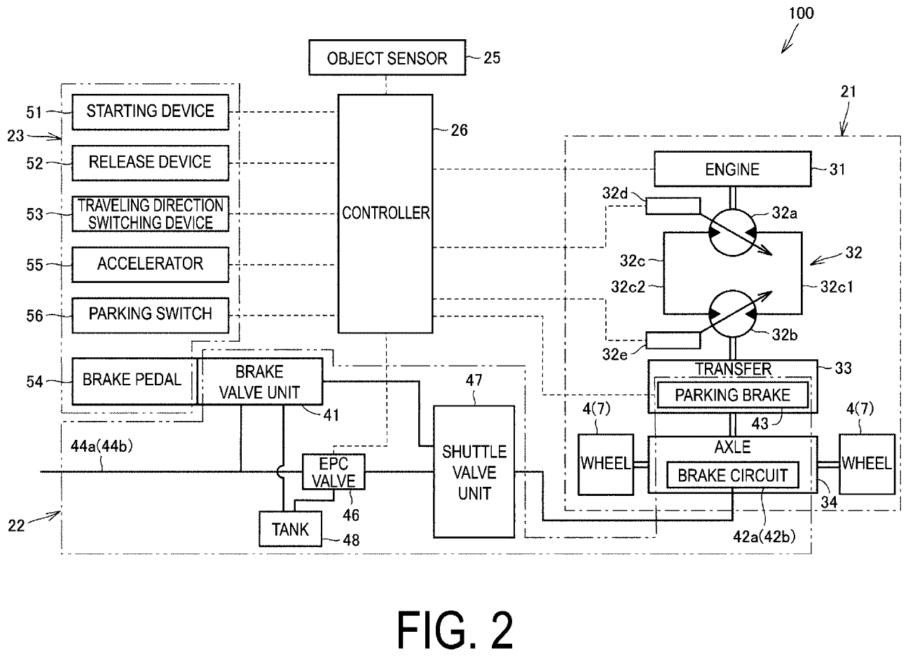

Next, a braking system of the wheel loader 100 in the present embodiment will be described with reference to FIGS. 2 to 5.

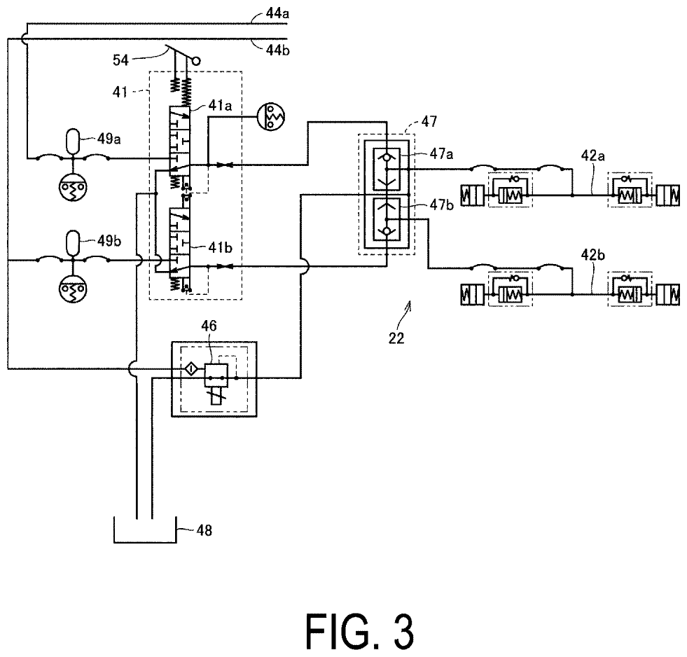

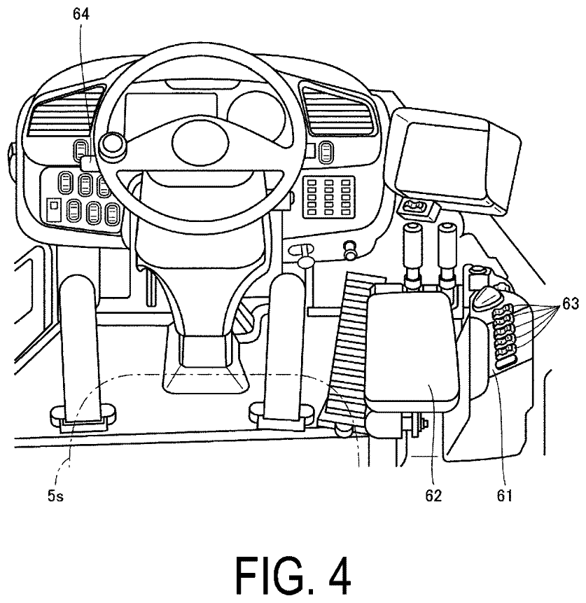

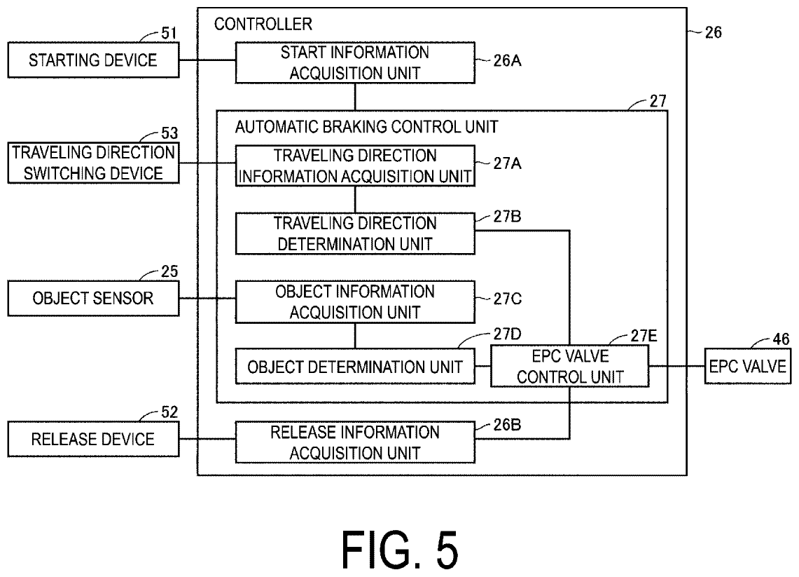

FIG. 2 is a block diagram illustrating the braking system for the wheel loader of FIG. 1. FIG. 3 is a hydraulic circuit diagram illustrating a configuration of the braking device of FIG. 2. FIG. 4 is a view illustrating arrangement positions of a traveling direction switching device and a release device. FIG. 5 is a block diagram illustrating a configuration of an operation device, an object sensor, and a controller in FIG. 2.

As illustrated in FIG. 2, the braking system of the wheel loader 100 includes a drive device 21, a braking device 22, an operation device 23, an object sensor 25, and a controller 26.

The drive device 21 drives the wheel loader 100. The braking device 22 brakes the wheel loader 100. The operation device 23 is operated by an operator. The object sensor 25 detects an object (obstacle) around the vehicle body 1. The controller 26 operates the drive device 21 and the braking device 22 based on the operation by the operator on the operation device 23 and the detection by the object sensor 25.

### Drive Device 21

As illustrated in FIG. 2, the drive device 21 includes an engine 31, a HST 32, a transfer 33, an axle 34, the front tire 4, and the rear tire 7.

The engine 31 is, for example, a diesel engine, and a driving force generated by the engine 31 drives a pump 32a of a HST (Hydro Static Transmission) 32.

The HST 32 includes the pump 32a, a motor 32b, and a hydraulic circuit 32c. The pump 32a is, for example, a swash plate type variable displacement pump, and an angle of a swash plate can be changed by a solenoid 32d. The pump 32a is driven by the engine 31 to discharge the hydraulic oil. The discharged hydraulic oil is sent to the motor 32c through the hydraulic circuit 32b. The motor 32b is, for example, a swash plate type pump, and an angle of a swash plate can be changed by a solenoid 32e.

The hydraulic circuit 32c connects the pump 32a and the motor 32b. The hydraulic circuit 32c includes a first drive circuit 32cl and a second drive circuit 32c2. When the hydraulic oil is supplied from the pump 32a to the motor 32b through the first drive circuit 32c1, the motor 32b is driven in one direction (for example, the forward direction). When the hydraulic oil is supplied from the pump 32a to the motor 32b through the second drive circuit 32c2, the motor 32b is driven in the other direction (for example, the reverse direction). The discharge direction of the hydraulic oil to the first drive circuit 32cl or the second drive circuit 32c2 can be changed by the solenoid 32d.

The transfer 33 distributes the output from the engine 31 to the front and rear axles 34.

The pair of front tires 4 are connected to the front axle 34, and are rotated by the distributed output from the engine 31. The pair of rear tires 7 are connected to the rear axle 34, and are rotated by the distributed output from the engine 31.

### Braking Device 22

As illustrated in FIG. 2, the braking device 22 performs braking of the vehicle body 1 based on the operation of the brake pedal 54 and performs automatic braking control of the vehicle body 1 based on a command from the controller 26.

The braking device 22 includes a brake valve unit 41, brake circuits 42a and 42b (an example of a service brake), a parking brake 43, hydraulic oil supply passages 44a and 44b, an EPC (Electric Proportional Valve) 46, a shuttle valve unit 47, and a tank 48.

Accumulators, pumps, and the like are connected to the hydraulic oil supply passages 44a and 44b, and the hydraulic oil is supplied.

As illustrated in FIG. 3, the brake valve unit 41 is operated by a brake pedal 54 to be described later. The brake valve unit 41 includes a rear brake valve 41a and a front brake valve 41b. Each of the rear brake valve 41a and the front brake valve 41b is a three position directional control valve having three ports.

The first port of the rear brake valve 41a is connected to the hydraulic oil supply passage 44a via the accumulator 49a. A second port of the rear brake valve 41a is connected to the tank 48. The third port of the rear brake valve 41a is connected to the rear shuttle valve 47a of the shuttle valve unit 47.

In the first state, the rear brake valve 41a connects the first port and the third port, connects the hydraulic oil supply passage 44a and the rear shuttle valve 47a, and supplies the hydraulic oil to the rear shuttle valve 47a. In the second state, the rear brake valve 41a closes all the ports. In the third state, the rear brake valve 41a connects the second port and the third port, and discharges the hydraulic oil between the rear shuttle valve 47a and the rear brake valve 41a to the tank 48. In the second state and the third state, the rear brake valve 41a stops the supply of the hydraulic oil to the rear shuttle valve 47a.

The first port of the front brake valve 41b is connected to the hydraulic oil supply passage 44b via the accumulator 49b. The second port of the front brake valve 41b is connected to the tank 48. The third port of the front brake valve 41b is connected to the front shuttle valve 47b of the shuttle valve unit 47.

In the first state, the front brake valve 41b connects the first port and the third port, connects the hydraulic oil supply passage 44b and the front shuttle valve 47b, and supplies the hydraulic oil to the front shuttle valve 47b. The front brake valve 41b closes all the ports in the second state. In the third state, the front brake valve 41b connects the second port and the third port, and discharges the hydraulic oil between the front shuttle valve 47b and the front brake valve 41b to the tank 48. The front brake valve 41b stops the supply of the hydraulic oil to the front shuttle valve 47b in the second state and the third state.

The opening degrees of the rear brake valve 41a and the front brake valve 41b are adjusted in accordance with the operation amount of the brake pedal 54, and the amount of hydraulic oil supplied to the shuttle valve unit 47 is changed. For example, when the operation amount of the brake pedal 54 is large, the amount of the hydraulic oil supplied from the rear brake valve 41a and the front brake valve 41b to the shuttle valve unit 47 increases.

The brake circuit 42a is provided on the rear axle 34 (FIG. 2). The brake circuit 42a is connected to the rear shuttle valve 47a. The brake circuit 42b is provided on the front axle 34 (FIG. 2). The brake circuit 42b is connected to the front shuttle valve 47b.

The brake circuits 42a and 42b are hydraulic brakes. The braking force of the brake circuit 42a increases as the amount or pressure of the hydraulic oil supplied from the rear shuttle valve 47a increases. The braking force of the brake circuit 42b increases as the amount or pressure of the hydraulic oil supplied from the front shuttle valve 47b increases.

The EPC valve 46 is connected to the hydraulic oil supply passage 44b. The EPC valve 46 is a solenoid valve having three ports. A first port of the EPC valve 46 is connected to the hydraulic oil supply passage 44b. A second port of the EPC valve 46 is connected to the tank 48. A third port of the EPC valve 46 is connected to the shuttle valve unit 47.

In the open state, the EPC valve 46 connects the first port and the third port, and supplies the hydraulic oil supplied from the hydraulic oil supply passage 44b to the shuttle valve unit 47. The opening degree of the EPC valve 46 is adjusted based on an instruction from the controller 26, and the amount of the hydraulic oil supplied to the shuttle valve unit 47 is changed.

When the EPC valve 46 is in the closed state, the first port is closed, the second port and the third port are connected, and the hydraulic oil in the flow path from the EPC valve 46 to the shuttle valve unit 47 is discharged to the tank 48. Thus, in the closed state, the EPC valve 46 stops the supply of the hydraulic oil from the hydraulic oil supply passage 44b to the shuttle valve unit 47.

In the present embodiment, the controller 26 controls the EPC valve 46 to the open state when the wheel loader 100 travels in a predetermined direction (for example, the rearward direction Zb) and it is determined that the risk of collision with an object in the traveling direction is high.

The shuttle valve unit 47 includes the rear shuttle valve 47a and the front shuttle valve 47b. The rear shuttle valve 47a supplies, to the brake circuit 42a, the hydraulic oil having a higher pressure between the hydraulic oil supplied via the rear brake valve 41a and the hydraulic oil supplied via the EPC valve 46. The front shuttle valve 47b supplies, to the brake circuit 42b, the hydraulic oil having a higher pressure between the hydraulic oil supplied via the front brake valve 41b and the hydraulic oil supplied via the EPC valve 46.

With such a configuration, even when the brake pedal 54 is not operated and the hydraulic oil is not supplied from the brake valve unit 41, the hydraulic oil is supplied from the rear shuttle valve 47a and the front shuttle valve 47b to the brake circuits 42a and 42b and the automatic braking control is performed when the EPC valve 46 is opened by the instruction from the controller 26.

The brake that is switched between the braking state and the non-braking state by the brake circuits 42a and 42b is, for example, a wet multi-plate disc brake. The wet multi-plate disc brake mainly includes a plurality of discs, a plate, a piston, and a spring. Each of the plurality of discs is integrated with an output shaft to the front tire 4 or the rear tire 7. The plates alternate with the discs and are attached to a fixed member and do not rotate. The piston is operated by the oil pressure of the hydraulic oil supplied to the brake circuits 42a and 42b. When the piston is operated, the plate is sandwiched and pressed between the plurality of discs. As a result, the wet multi-plate disc brake is operated to be in a braking state. When the supply of the hydraulic oil to the brake circuits 42a and 42b is stopped, the piston is returned to the original position by the repulsive force (restoring force) of the spring, and the pressed state between the plate and the disc is released. As a result, the wet multi-plate disc brake is brought into a non-braking state.

As illustrated in FIG. 2, the parking brake 43 is provided in the transfer 33. As the parking brake 43, for example, a wet multi-stage brake capable of switching between a braking state and a non-braking state, a disc brake, or the like can be used.

### Operation Device 23

As illustrated in FIG. 2, the operation device 23 is operated by an operator who rides in the cab 5 (FIG. 1). The operation device 23 includes a starting device 51, a release device 52, the traveling direction switching device 53, the brake pedal 54, the accelerator 55, and a parking switch 56.

The starting device 51 is provided in the cab 5. The starting device 51 is, for example, a key switch. The operator can switch from the OFF state to the ON state by an operation such as inserting a key into the key switch 51. As a result, an operation signal indicating the ON state or the OFF state is transmitted from the key switch 51 to the controller 26. When the controller 26 acquires the operation signal in the ON state, the controller 26 controls the engine 31 to start and starts the automatic braking control. When the controller 26 acquires the operation signal of the OFF state, the controller 26 stops the engine 31.

The release device 52 is provided in the cab 5. As illustrated in FIG. 4, the release device 52 may be disposed in a console 61 disposed on the side of the operator seat 5s. For example, any one of the plurality of switches 63 disposed in the console 61 may be set in the release device 52. An arm rest 62 may be disposed between the operator seat 5s and the console 61.

As illustrated in FIG. 2, the operator operates the release device 52 to release the automatic braking control. A release signal is transmitted from the release device 52 to the controller 26 by an operation by the operator. When acquiring the release signal, the controller 26 closes the EPC valve 46 to release the automatic braking control.

The traveling direction switching device 53 is provided in the cab 5. As illustrated in FIG. 4, the traveling direction switching device 53 may be a lever 64 of a type protruding from the steering column, or may be a lever of a type protruding from the floor of the cab 5.

As illustrated in FIG. 2, the operator operates the traveling direction switching device 53 to set the traveling direction of the wheel loader 100. The traveling direction switching device 53 is, for example, an FNR lever. The FNR lever 53 can take a lever position of forward (F), neutral (N), or reverse (R). An operation signal indicating the lever position of the FNR lever 53 is transmitted to the controller 26, and the controller 26 switches the traveling direction to forward, neutral, or reverse by controlling the solenoid 32d.

As a position detection sensor that detects the lever position of the FNR lever 53, a potentiometer may be used, or a switch may be provided for each of the forward drive position, the reverse drive position, and the neutral position. Further, both the potentiometer and the switch may be provided so as to be able to detect an erroneous operation even if one of the potentiometer and the switch is erroneously operated.

The brake pedal 54 is provided in the cab 5. The brake pedal 54 adjusts the opening degrees of the rear brake valve 41a and the front brake valve 41b of the brake valve unit 41.

The accelerator 55 is provided in the cab 5. The operator operates the accelerator 55 to set the throttle opening degree. The accelerator 55 generates an opening degree signal indicating an accelerator operation amount and transmits the opening degree signal to the controller 26. The controller 26 controls the rotational speed of the engine 31 based on the transmitted signal.

The parking switch 56 is provided in the cab 5, is a switch whose state can be switched between on and off, and transmits a signal indicating the state to the controller 26. The controller 26 puts the parking brake 43 into a braking state or a non-braking state based on the transmitted signal.

### Object Sensor 25

As illustrated in FIG. 2, the object sensor 25 detects an object around the vehicle body 1. The object sensor 25 detects an object located in the traveling direction of the wheel loader 100. Specifically, the object sensor 25 is a rear detection unit that detects an object in the rearward direction Zb of the vehicle body 1 when the wheel loader 100 travels in the rearward direction Zb. The object sensor 25 is a front detection unit that detects an object in the frontward direction Zf of the vehicle body 1 when the wheel loader 100 travels in the frontward direction Zf.

When the object sensor 25 is a rear detection unit, the rear detection unit 25 is attached to, for example, the rear end of the vehicle body 1 as illustrated in FIG. 1, but may be attached to a position other than the rear end. In a case where the object sensor 25 is the front detection unit, the front detection unit 25 may be attached to, for example, the cab 5, may be attached to the front frame 11, or may be attached to other components.

The object sensor 25 is, for example, a LiDAR (Light Detection and Ranging) sensor that emits laser light to acquire information on a target object. The object sensor 25 may be a radar (Radio Detection and Ranging) that acquires information on an object by emitting radio waves. The radar may be, for example, a millimeter-wave radar that uses a reception antenna to detect a state in which a radio wave in a millimeter-wave band emitted from a transmission antenna is reflected by a surface of an object and returns. The object sensor 25 may be a visual sensor including a camera. The object sensor 25 may be an infrared sensor.

Information detected by the object sensor 25 is transmitted to the controller 26, and the controller 26 determines whether an object is present in the traveling direction of the vehicle body 1. Further, the controller 26 calculates a distance to the detected object. The controller 26 may determine whether the risk of the vehicle body 1 colliding with the object is high based on the distance to the detected object or the like.

### Controller 26

The controller 26 includes a processor, a main memory, and a storage. The processor is, for example, a CPU (Central Processing Unit). The main memory includes, for example, a nonvolatile memory such as a ROM (Read Only Memory) and a volatile memory such as a RAM (Random Access Memory).

The controller 26 may be mounted on the wheel loader 100, or may be disposed outside and away from the wheel loader 100. In a case where the controller 26 is disposed separately outside the wheel loader 100, the controller 26 may be wirelessly connected to the drive device 21, the braking device 22, the operation device 23, the object sensor 25, and the like.

The controller 26 reads a program stored in the storage, expands the program in the main memory, and executes a predetermined process according to the program. The controller 26 may be divided into a collision detection controller and an HST controller. The collision detection controller and the HST controller may have different CPUs. Alternatively, the program may be distributed to the controller 26 via a network.

As illustrated in FIG. 5, the controller 26 includes a start information acquisition unit 26A, a release information acquisition unit 26B, and an automatic braking control unit 27. The automatic braking control unit 27 includes a traveling direction information acquisition unit 27A, a traveling direction determination unit 27B, an object information acquisition unit 27C, an object determination unit 27D, and an EPC valve control unit 27E.

The start information acquisition unit 26A acquires an operation signal indicating an ON state or an OFF state from the starting device 51. When the operation signal indicating the ON state is acquired from the starting device 51, the start information acquisition unit 26A outputs the acquired signal to the automatic braking control unit 27.

The automatic braking control unit 27 starts the automatic braking control when the operation signal indicating the ON state is acquired from the start information acquisition unit 26A. The state (ON state) in which the automatic braking control is started means a state in which the controller 26 can automatically control the opening and closing operation of the EPC valve 46 based on the detection result of the traveling direction switching device 53 and the detection result of the object sensor 25. In a state where the automatic braking control is started, the open/closed state of the EPC valve 46 can be controlled between the closed state and the open state.

When the automatic braking control unit 27 starts the automatic braking control, the traveling direction information acquisition unit 27A acquires the switching signal of the traveling direction switching device 53. The traveling direction information acquisition unit 27A outputs the acquired switching signal of the traveling direction switching device 53 to the traveling direction determination unit 27B.

When acquiring the switching signal of the traveling direction switching device 53, the traveling direction determination unit 27B determines whether the traveling direction of the wheel loader 100 is a predetermined direction (for example, the rearward direction Zb) based on the switching signal of the traveling direction switching device 53. The traveling direction determination unit 27B outputs the determination result to the EPC valve control unit 27E.

Even in a stopped state in which the wheels 4 and 7 are not rotating, when the lever position of the traveling direction switching device 53 is in a predetermined direction (for example, the rearward direction Zb), the traveling direction determination unit 27B may determine that the vehicle body 1 is traveling in the predetermined direction (backward traveling state).

When the automatic braking control unit 27 starts the automatic braking control, the object information acquisition unit 27C acquires the detection result of the object sensor 25. The object information acquisition unit 27C outputs the acquired detection result of the object sensor 25 to the object determination unit 27D. The object determination unit 27D determines whether the risk of collision of the vehicle body 1 with an object is high based on the detection result of the object sensor 25 or the like, and outputs the determination result to the EPC valve control unit 27E.

The EPC valve control unit 27E controls the opening and closing operation of the EPC valve 46 based on the determination result of the traveling direction determination unit 27B and the determination result of the object determination unit 27D during the execution of the automatic braking control. To be specific, during the execution of the automatic braking control, when the EPC valve control unit 27E acquires, for example, the determination result by the traveling direction determination unit 27B that the traveling direction is the rearward direction Zb and the determination result by the object determination unit 27D that the risk of collision of the vehicle body 1 with an object is high, the EPC valve control unit 27E outputs an open command (command current) to the EPC valve 46 so that the EPC valve 46 is brought into the open state. The solenoid of the EPC valve 46 is operated based on the command current, so that the EPC valve 46 is opened. When the EPC valve 46 is opened, the hydraulic oil is supplied from the rear shuttle valve 47a and the front shuttle valve 47b to the brake circuits 42a and 42b, and the braking operation is executed.

The state in which the braking operation is executed (ON state) means a state in which the braking force by the brake circuits 42a and 42b is acting. An example of the case where a braking operation is being performed means that, when the brake is a wet multi-plate disc brake, a plate is sandwiched and pressed between a plurality of discs. On the other hand, a state where the braking operation is not executed (OFF state) means a state where the braking force by the brake circuits 42a and 42b does not act. An example of the case where the braking operation is not performed means that, in a case where the brake is a wet multi-plate disc brake, a plate is not sandwiched and pressed between a plurality of discs.

The opening degree of the EPC valve 46 is adjusted by a command current output from the EPC valve control unit 27E to the EPC valve 46. In this example, the command current is set to a predetermined value in advance. The command current may be adjusted based on the distance to the detected object. For example, the EPC valve control unit 27E may calculate a deceleration for stopping before the object based on the detected distances to the object, and transmit an open command (command current) to the EPC valve 46 so that the EPC valve 46 has an opening degree that achieves the deceleration.

As described above, the controller 26 executes the automatic braking control for automatically braking traveling based on the detection result of the object in the traveling direction. In the automatic braking control, the controller 26 automatically controls the traveling by the braking device 22 based on the detection result of the object by the object sensor 25. As a result, even when the brake pedal 54 is not operated by the operator, the automatic braking control is executed to exert the braking force, and the vehicle body 1 can be stopped before the object.

The release information acquisition unit 26B acquires a release signal of the automatic braking control from the release device 52. The release information acquisition unit 26B outputs the acquired release signal to the EPC valve control unit 27E. When acquiring the release signal during the automatic braking control, the EPC valve control unit 27E controls the EPC valve 47a to be in the closed state based on the release signal. The EPC valve control unit 27E controls the EPC valve 47a to be in the closed state based on the release signal. When the EPC valve 46 is closed, the supply of hydraulic oil from the rear shuttle valve 47a and the front shuttle valve 47b to the brake circuits 42a and 42b is stopped, and the automatic braking control is released.

As described above, the controller 26 detects that the release device 52 is operated during the automatic braking control, and releases the automatic braking control based on the release signal from the release device 52. The state (OFF state) in which the automatic braking control is released means a state in which the controller 26 cannot automatically control the opening/closing operation of the EPC valve 46 based on the detection result of the traveling direction switching device 53 and the detection result of the object sensor 25. In a state where the automatic braking control is released (OFF state), the EPC valve 47a is in a closed state.

Even when the automatic braking control is released, at least the determination result by the traveling direction determination unit 27E is continuously input to the EPC valve control unit 27B. However, when the automatic braking control is released, since the EPC valve 47a is in the closed state, the EPC valve 46 is not brought into the open state even if the determination result by the traveling direction determination unit 27E is input to the EPC valve control unit 27B. Therefore, when the automatic braking control is released, the braking force by the automatic braking control is not exerted.

In this way, even when the braking force by the automatic braking control is not exerted, when the operator operates the brake pedal 54 as illustrated in FIG. 2, the hydraulic oil is supplied from the brake valve unit 41 to the shuttle valve unit 47, and the brake circuits 42a and 42b are operated.

As illustrated in FIG. 5, when the traveling direction is switched by the traveling direction switching device 53 in the release state of the automatic braking control, a signal of the determination result indicating that the traveling direction has been switched is output from the traveling direction determination unit 27B to the EPC valve control unit 27E. When the EPC valve control unit 27E acquires the signal of the determination result indicating that the traveling direction is switched in the release state of the automatic braking control, the EPC valve control unit 27E returns (resumes) the automatic braking control.

In this manner, the controller 26 returns the automatic braking control, which is released by the operation of the release device 52, based on the switching signal of the traveling direction in the traveling direction switching device 53. The controller 26 returns the automatic braking control when the traveling direction switching device is switched from reverse to forward or neutral, for example. After the automatic braking control is released by the release device 52, the controller 26 maintains the release state of the automatic braking control until the automatic braking control is returned based on the switching signal of the traveling direction.

Although the braking operation of the automatic braking control in the case where an object is present in the rearward direction of vehicle body 1 when the wheel loader 100 moves backward has been described above, the braking operation of the automatic braking control in the present disclosure is similarly applicable to the case where an object is present in the frontward direction of vehicle body 1 when the wheel loader 100 moves forward. In this case, the braking operation by the automatic braking control is executed when the wheel loader 100 is moving forward and there is a high risk of collision with an object in the frontward direction. In addition, after the automatic braking control is released by the operation of the release device 52, the automatic braking control is returned when the traveling direction switching device 53 is switched to reverse or neutral other than forward.

### Control Method for Wheel Loader 100

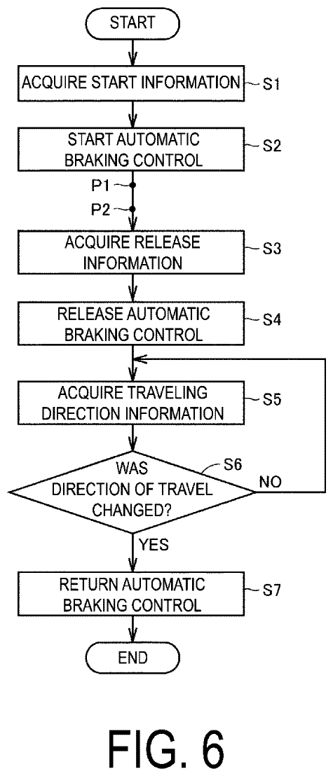

Next, a control method for the wheel loader 100 in the present embodiment will be described with reference to FIGS. 6 to 8.

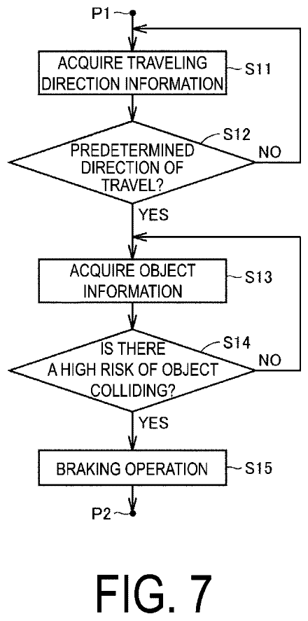

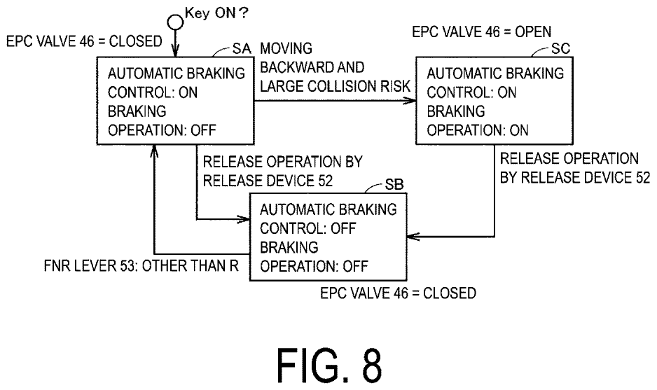

FIGS. 6 and 7 are a first flowchart and a second flowchart, respectively, illustrating a control method for a wheel loader according to an embodiment of the present disclosure. FIG. 8 is a diagram illustrating the transition between the ON state and the OFF state of the automatic braking control and the braking operation.

As illustrated in FIGS. 5 and 6, the operator operates the starting device 51 to start. For example, the operator inserts a key into the key switch corresponding to the starting device 51 to operate the wheel loader 100 from the OFF state to the ON state. Accordingly, an operation signal (start information) indicating the ON state is output from the starting device 51 to the start information acquisition unit 26A of the controller 26, and the start information acquisition unit 26A acquires the start information (step S1: FIG. 6).

When the start information acquisition unit 26A acquires the start information, the acquired signal is output to the automatic braking control unit 27. When acquiring the start information from the start information acquisition unit 26A, the automatic braking control unit 27 starts the automatic braking control (step S2: FIG. 6).

This state corresponds to the state SA illustrated in FIG. 8. In the state SA, the automatic braking control is executed (ON). However, in the state SA, since the condition for executing the braking operation in the automatic braking control (for example, the traveling direction is backward, and the possibility of collision with the object in the traveling direction is high) is not satisfied, the braking operation is not executed. Therefore, the EPC valve 46 is in a closed state.

In this state SA, the operator operates the release device 52 to perform a release operation of the automatic braking control. For example, as illustrated in FIG. 4, the operator performs the release operation by operating the switch 63 set as the release device 52.

As illustrated in FIGS. 5 and 6, by the release operation of the release device 52, a release signal (release information) is output from the release device 52 to the release information acquisition unit 26B of the controller 26. Accordingly, the release information acquisition unit 26B acquires the release information (step S3: FIG. 6).

When the release information acquisition unit 26B acquires the release information, the release information acquisition unit 26B outputs the acquired signal to the automatic braking control unit 27. When the release signal is acquired from the release information acquisition unit 26B, the automatic braking control unit 27 releases (stops) the automatic braking control and maintains the released state (step S4: FIG. 6).

To be more specific, the release information acquisition unit 26B outputs a release signal to the EPC valve control unit 27E, and the EPC valve control unit 27E controls the EPC valve 47a to maintain the closed state based on the release signal. Since the EPC valve 46 is controlled to maintain the closed state, the braking operation is not performed even if the condition for performing the braking operation in the automatic braking control (for example, the traveling direction is backward and the possibility of collision with an object in the traveling direction is high) is satisfied in this state.

This state corresponds to the state SB illustrated in FIG. 8. In the state SB, the automatic braking control is released (OFF). Therefore, in the state SB, even if the condition for executing the braking operation in the automatic braking control (for example, the traveling direction is backward and the possibility of collision with an object in the traveling direction is high) is satisfied, the braking operation is not executed.

In this state SB, the operator operates the traveling direction switching device 53 to perform a traveling direction switching operation. For example, as illustrated in FIG. 4, the operator operates the lever 64 set as the traveling direction switching device 53 to perform the traveling direction switching operation.

As illustrated in FIGS. 5 and 6, by the traveling direction switching operation of the traveling direction switching device 53, a traveling direction switching signal is output from the traveling direction switching device 53 to the traveling direction information acquisition unit 27A of the controller 26. Accordingly, the traveling direction information acquisition unit 27A acquires the traveling direction switching signal (step S5: FIG. 6).

The traveling direction information acquisition unit 27A outputs the acquired traveling direction switching signal to the traveling direction determination unit 27B. The traveling direction determination unit 27B determines whether the traveling direction has been switched based on the traveling direction switching signal (step S6: FIG. 6).

When the traveling direction determination unit 27B determines that the traveling direction has not been switched, the traveling direction information acquisition unit 27A repeats acquiring the traveling direction information (step S5) and determining the traveling direction (step S6).

When the traveling direction determination unit 27B determines that the traveling direction has been switched, the automatic braking control is returned (restarted) (step S7: FIG. 6). In this way, the release state of the automatic braking control is maintained until the traveling direction determination unit 27B determines that the traveling direction is switched.

This state corresponds to the state SA illustrated in FIG. 8.

Although the case where the state transitions in the order of state SA→state SB→state SA in FIG. 8 has been described above, the present disclosure can also be applied to a case where the state transitions in the order of state SA→state SC→state SB→state SA.

Hereinafter, a control method when the state transitions in the order of state SA→state SC→state SB→state SA will be described.

When the state transitions in the order of state SA→state SC→state SB→state SA, a step illustrated in FIG. 7 is added between a point P1 and a point P2 illustrated in FIG. 6.

As illustrated in FIG. 6, after the start of the automatic braking control (step S2), the operator causes the vehicle body 1 to travel. In this case, as illustrated in FIG. 2, the operator sets the traveling direction of the traveling direction switching device 53 to a desired traveling direction, and operates the accelerator 55. Thus, the vehicle body 1 travels in the set traveling direction. This traveling direction is, for example, the rearward direction Zb, and the vehicle body 1 moves backward.

As illustrated in FIGS. 5 and 7, at this time, the traveling direction information acquisition unit 27A of the controller 26 acquires a switching signal of the traveling direction in the traveling direction switching device 53 (step S11: FIG. 7). The traveling direction information acquisition unit 27A outputs the acquired switching signal of the traveling direction to the traveling direction determination unit 27B.

When acquiring the switching signal of the traveling direction switching device 53, the traveling direction determination unit 27B determines whether the traveling direction is a predetermined direction (for example, the rearward direction Zb) based on the switching signal of the traveling direction switching device 53 (step S12: FIG. 7).

When the traveling direction determination unit 27B determines that the traveling direction of the vehicle body 1 is not the predetermined direction, the acquisition of the traveling direction information (step S11) and the determination of whether the traveling direction is the predetermined direction (step S12) are repeated. On the other hand, when the traveling direction determination unit 27B determines that the traveling direction of the vehicle body 1 is the predetermined direction, the traveling direction determination unit 27B outputs the determination result to the EPC valve control unit 27E.

Further, after the automatic braking control is started (step S2), the object information acquisition unit 27C of the controller 26 acquires the detection result (object information) of the object sensor 25 (step S13: FIG. 7). The object information acquisition unit 27C outputs the acquired detection result of the object sensor 25 to the object determination unit 27D. The object determination unit 27D determines whether the risk of collision of the vehicle body 1 with the object is high based on the detection result of the object sensor 25 and the like (step S14: FIG. 7).

When the object determination unit 27D determines that the risk of collision of the vehicle body 1 with the object is not high, the acquisition of the object information (step S13) and the determination of whether the risk of collision with the object is high (step S14) are repeated. On the other hand, when the object determination unit 27D determines that the risk of collision of the vehicle body 1 with the object is high, the object determination unit 27D outputs the determination result to the EPC valve control unit 27E.

The EPC valve control unit 27E executes the braking operation based on the determination result of the traveling direction determination unit 27B and the determination result of the object determination unit 27D (step S15: FIG. 7). The EPC valve control unit 27E outputs an open command (command current) to the EPC valve 46 so as to open the EPC valve 46, for example, when the EPC valve control unit 27E acquires a determination result that the traveling direction is a predetermined direction (for example, the rearward direction Zb) and a determination result that the risk of collision of the vehicle body 1 with an object is high. The solenoid of the EPC valve 46 is operated based on the command current, so that the EPC valve 46 is opened. When the EPC valve 46 is opened, the hydraulic oil is supplied from the rear shuttle valve 47a and the front shuttle valve 47b to the brake circuits 42a and 42b, and the braking operation is automatically executed.

This state corresponds to the state SC illustrated in FIG. 8. In the state SC, the automatic braking control is executed (ON), the braking operation is also executed (ON), and the braking force is applied to the vehicle body 1.

However, for example, in the case of parking in a narrow place such as parking between two other vehicles, the other vehicle itself may be erroneously detected as an obstacle, and erroneous braking may be unintentionally caused even in a situation where braking is not required. In such a case, it is necessary to release the automatic braking control and continue parking.

Therefore, in such a case, the operator operates the release device 52 from the state SC to perform the release operation of the automatic braking control. For example, as illustrated in FIG. 4, the operator performs the release operation by operating the switch 63 set as the release device 52.

Since the subsequent control method is the same as steps S3 to S7 illustrated in FIG. 6, the description thereof will not be repeated.

Note that steps S11 and S12 in FIG. 7 may be performed after steps S13 and S14, or may be performed simultaneously with steps S13 and S14.

As in the transition of state SA→state SB→state SA in FIG. 8, the controller 26 may release the automatic braking control by the operation of the release device 52 before the object in the traveling direction is detected. Further, as in the transition of state SA→state SC→state SB→state SA in FIG. 8, the controller 26 may release the automatic braking control by the operation of the release device 52 in a state where the traveling is braked based on the detection result of the object.

### Effects

Next, effects of the present embodiment will be described.

In the present disclosure, as illustrated in FIG. 5, the automatic braking control released by the operation of the release device 52 is returned based on the switching signal of the traveling direction in the traveling direction switching device 53. As a result, after the automatic braking control is released, the released state of the automatic braking control is maintained until the automatic braking control is returned based on the switching signal of the traveling direction. Therefore, it is not necessary for the operator to continuously operate the release device 52 in order to continuously release the automatic braking control. This eliminates the need for the operator to operate the release device 52 when operating the travel of the work machine and the operation of the work implement, so that a driving operation is less likely to be hindered.

Further, as illustrated in FIG. 2, in the automatic braking control, the traveling is automatically braked by the braking device 22 based on the detection result of the object by the object sensor 25. This can reduce the risk of collision of the vehicle body 1 with an object.

As illustrated in FIGS. 5 and 8, in the state SC in which the traveling is braked based on the detection result of the object, the controller 26 may perform control to release the automatic braking control by the operation of the release device 52 and transition to the state SB. Thus, even when another vehicle itself is erroneously detected as an obstacle and erroneous braking occurs in parking in a narrow place such as parking between two vehicles, the automatic braking control is released and the parking can be continued.

Further, as illustrated in FIGS. 5 and 8, in the state SA before the detection of the object, the controller 26 may perform control so as to release the automatic braking control by the operation of the release device 52 and transition to the state SB. This improves the degree of freedom of the operation by the operator.

Further, as illustrated in FIGS. 5 and 8, the controller 26 may return the automatic braking control when the traveling direction switching device 53 is switched from reverse to forward or neutral. As a result, it is possible to reduce the risk of collision with an object at the time of backward movement.

As illustrated in FIG. 4, the release device 52 is disposed in the console 61 disposed on the side of the operator seat 5s for an operator to sit on. This makes it easier for the operator to operate the release device 52.

### Appendices

The above description includes the following features.

### Appendix 1

A work machine configured to perform automatic braking control for automatically braking traveling based on a detection result of an obstacle, the work machine including: a release device configured to release the automatic braking control by an operation by an operator; a traveling direction switching device configured to switch a traveling direction by an operation by the operator; and a controller configured to return the automatic braking control released by an operation of the release device based on a switching signal of the traveling direction in the traveling direction switching device.

### Appendix 2

The work machine according to Appendix 1, further including: a braking device configured to brake traveling; and an object sensor configured to detect an obstacle located in a traveling direction of the work machine, wherein in the automatic braking control, the controller automatically brakes traveling by the braking device based on a detection result of the obstacle by the object sensor.

### Appendix 3

The work machine according to Appendix 1 or 2, wherein the controller releases the automatic braking control by an operation of the release device in a state where the traveling is braked based on a detection result of an obstacle.

### Appendix 4

The work machine according to Appendix 1 or 2, wherein the controller releases the automatic braking control by an operation of the release device before an obstacle is detected.

### Appendix 5

The work machine according to any one of Appendices 1 to 4, wherein the controller returns the automatic braking control when the traveling direction switching device is switched from reverse to forward or neutral.

### Appendix 6

The work machine according to any one of Appendices 1 to 5, further including: an operator seat for an operator to sit on; and a console disposed on the side of the operator seat, wherein the release device is disposed in the console.

### Appendix 7

A braking system for a work machine configured to perform automatic braking control for automatically braking traveling based on a detection result of an obstacle, the braking system including: a release device configured to release the automatic braking control by an operation by an operator; a traveling direction switching device configured to switch a traveling direction by an operation by the operator; and a controller configured to return the automatic braking control released by an operation of the release device based on a switching signal of the traveling direction in the traveling direction switching device.

### Appendix 8

A control method for a work machine configured to perform automatic braking control for automatically braking traveling based on a detection result of an obstacle, the control method including: releasing the automatic braking control; and returning the released automatic braking control based on a switching signal of a traveling direction.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 Vehicle body, 2 Traveling body, 3 Work implement, 4 Front tire, 5 Cab, 5s Operator seat, 6 Engine room, 7 Rear tire, 9 Steering cylinder, 10 Vehicle body frame, 11 Front frame, 12 Rear frame, 13 Coupling shaft portion, 14 Boom, 15 Bucket, 16 Lift cylinder, 17 Bucket cylinder, 18 Bell crank, 21 Drive device, 22 Braking device, 23 Operation device, 25 Object sensor, 26 Controller, 26A Start information acquisition unit, 26B Release information acquisition unit, 27 Automatic braking control unit, 27A Traveling direction information acquisition unit, 27B Traveling direction determination unit, 27C Object information acquisition unit, 27D Object determination unit, 27E Valve control unit, 31 Engine, 32a Pump, 32b Motor, 32c Hydraulic circuit, 32cl First drive circuit, 32c2 Second drive circuit, 32d, 32e Solenoid, 33 Transfer, 34 Axle, 41 Brake valve unit, 41a Rear brake valve, 41b Front brake valve, 42a, 42b Brake circuit, 43 Parking brake, 44a, 44b Hydraulic oil supply passage, 46 EPC valve, 47 Shuttle valve unit, 47a Rear shuttle valve, 47b Front shuttle valve, 48 Tank, 49a, 49b Accumulator, 51 Starting device, 52 Release device, 53 Traveling direction switching device, 54 Brake pedal, 55 Accelerator, 56 Parking switch, 61 Console, 62 Arm rest, 63 Switch, 64 Lever, 100 Wheel loader

1. A work machine configured to perform automatic braking control for automatically braking traveling based on a detection result of an obstacle, the work machine comprising:
a release device configured to release the automatic braking control by an operation by an operator;
a traveling direction switching device configured to switch a traveling direction by an operation by the operator; and
a controller configured to return the automatic braking control released by an operation of the release device based on a switching signal of the traveling direction in the traveling direction switching device.

2. The work machine according to claim 1, further comprising:
a braking device configured to brake traveling; and
an object sensor configured to detect an obstacle located in a traveling direction of the work machine, wherein
in the automatic braking control, the controller automatically brakes traveling by the braking device based on a detection result of the obstacle by the object sensor.

3. The work machine according to claim 1, wherein
the controller releases the automatic braking control by an operation of the release device in a state where the traveling is braked based on a detection result of an obstacle.

4. The work machine according to claim 1, wherein
the controller releases the automatic braking control by an operation of the release device before an obstacle is detected.

5. The work machine according to claim 1, wherein
the controller returns the automatic braking control when the traveling direction switching device is switched from reverse to forward or neutral.

6. The work machine according to claim 1, further comprising:
an operator seat for an operator to sit on; and
a console disposed on the side of the operator seat, wherein
the release device is disposed in the console.

7. A braking system for a work machine configured to perform automatic braking control for automatically braking traveling based on a detection result of an obstacle, the braking system comprising:
a release device configured to release the automatic braking control by an operation by an operator;
a traveling direction switching device configured to switch a traveling direction by an operation by the operator; and
a controller configured to return the automatic braking control released by an operation of the release device based on a switching signal of the traveling direction in the traveling direction switching device.

8. A control method for a work machine configured to perform automatic braking control for automatically braking traveling based on a detection result of an obstacle, the control method comprising:
releasing the automatic braking control; and
returning the released automatic braking control based on a switching signal of a traveling direction.
